(19) United States
(12) Patent Application Publication
(10) Pub. No.: US 2024/0401700 A1
(43) Pub. Date: Dec. 5, 2024

(54) SPRING-LOADED GLAND WALL SEAL CARRIER FOR REVERSE ACTING DIFFERENTIAL PRESSURE

(71) Applicant: KALSI ENGINEERING, INC., Sugar Land, TX (US)

(72) Inventor: Jeffrey David Gobeli, Houston, TX (US)

(73) Assignee: KALSI ENGINEERING, INC., Sugar Land, TX (US)

(21) Appl. No.: 18/680,444

(22) Filed: May 31, 2024

Related U.S. Application Data
(60) Provisional application No. 63/577,907, filed on May 31, 2023.

(51) Int. Cl. F16J 15/16; F16J 15/3204

(52) U.S. Cl. CPC F16J 15/164; F16J 15/3204

(57) ABSTRACT

A sealing assembly for forward and reverse differential pressure, the sealing assembly including a housing having a first bore portion joined by a housing surface to a second bore portion, a shaft relatively movable with respect to the housing, an annular seal carrier located radially outward of and encircling at least a portion of the shaft. The seal carrier has an annular neck transitioning to an outwardly extending wall and having an axial extension adjoining the outwardly extending wall. The annular neck extends through the first bore portion and the axial extension and wall is positioned within the second bore portion. A dynamic seal is located between and has sealing contact with the axial extension and the shaft and partitions a lubricant fluid from an environment fluid. The dynamic seal has a lubricant fluid side exposed to the lubricant fluid and an environment fluid side exposed to the environment fluid. An end cap having an inner axial extension with an end face is secured to the housing. A spring is located around the neck and between the housing surface and the outwardly extending wall of the seal carrier. The seal carrier is allowed to have limited axial movement relative to the housing and the end cap and the dynamic seal is axially located between the end face of the end cap and the outwardly extending wall of the seal carrier.

### CROSS-REFERENCE TO RELATED APPLICATIONS

This application claims the benefit of U.S. Provisional Application Ser. No. 63/577,907 filed on May 31, 2023, by Jeffrey David Gobeli, entitled “Spring-Loaded Gland Wall Seal Carrier For Reverse Acting Differential Pressure.” Applicant incorporates by reference herein Application Ser. No. 63/577,907 in its entirety.

### BACKGROUND OF THE INVENTION

### 1. Field of the Invention

The present invention relates generally to a sealing arrangement for rotating equipment, and more particularly to a sealing arrangement for rotating equipment in which differential pressure across a seal may reverse in direction.

### 2. Description of the Related Art

The present invention is related to equipment having relatively movable machine components and a sealing arrangement separating a lubricant-type first fluid from a second or environment fluid. The invention typically includes a movable shaft, where a pressure-retaining seal establishes sealing contact with the relatively movable shaft to retain the lubricant fluid and partition the lubricant fluid from the environment fluid.

In some sealing applications the differential pressure acting across the seal may reverse in direction. This reversing differential pressure can cause skew-induced wear of the seal. For purposes of this application, forward differential pressure is defined as the differential pressure acting from the lubricant side of the seal and reverse differential pressure refers to the differential pressure across a seal acting from the environment side. When the environment fluid is abrasive, additional skew-induced wear of the seal may occur with reverse differential pressure.

To prevent skew-induced seal wear, many seals require axial spring loading when there is reversing differential pressure, and additionally if the environment fluid is abrasive. However, many of these designs are only suitable for instances where the environment fluid pressure may occasionally exceed the lubricant fluid pressure

It is desirable to have a sealing assembly capable of handling higher reverse pressure loads than prior designs. It is also desirable to have a sealing assembly capable of handling a broader range of reverse pressures than prior designs.

### SUMMARY OF THE INVENTION

The present invention is a sealing assembly capable of handling higher reverse pressure loads than prior designs. The present invention is capable of handling a broader range of reverse pressures than prior designs.

One aspect of the invention comprises a sealing assembly for forward and reverse differential pressure, the sealing assembly including a housing having a first bore portion joined by a housing surface to a second bore portion, a shaft relatively movable with respect to the housing, an annular seal carrier located radially outward of and encircling at least a portion of the shaft. The seal carrier has an annular neck transitioning to an outwardly extending wall and having an axial extension adjoining the outwardly extending wall. The annular neck extends through the first bore portion and the axial extension and wall is positioned within the second bore portion. A dynamic seal is located between and has sealing contact with the axial extension and the shaft and partitions a lubricant fluid from an environment fluid. The dynamic seal has a lubricant fluid side exposed to the lubricant fluid and an environment fluid side exposed to the environment fluid. An end cap having an inner axial extension with an end face is secured to the housing. A spring is located around the neck and between the housing surface and the outwardly extending wall of the seal carrier. The seal carrier is allowed to have limited axial movement relative to the housing and the end cap and the dynamic seal is axially located between the end face of the end cap and the outwardly extending wall of the seal carrier.

### BRIEF DESCRIPTION OF THE SEVERAL VIEWS OF THE DRAWINGS

The invention is better understood by reading the detailed description of embodiments which follows and by examining the accompanying drawings, in which:

FIG. 1 is a fragmentary longitudinal cross-sectional view of a sealing arrangement that is representative of a preferred embodiment of the present invention; and

FIG. 2 is a fragmentary longitudinal cross-sectional view of a sealing arrangement that is representative of another preferred embodiment of the present invention.

### DESCRIPTION OF THE PREFERRED EMBODIMENTS

It should be understood at the outset that although illustrative implementations of one or more embodiments are described below, the disclosed assemblies, systems, and methods may be implemented using any number of techniques, whether currently known or not yet in existence. The disclosure should in no way be limited to the illustrative implementations, drawings, and techniques described below, but may be modified within the scope of the appended claims along with their full scope of equivalents.

The following brief definition of terms shall apply throughout the application:

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);
If the specification describes something as “exemplary” or an “example,” it should be understood that refers to a non-exclusive example;
The terms “about” or “approximately” or the like, when used with a number, may mean that specific number, or alternatively, a range in proximity to the specific number, as understood by persons of skill in the field of the art;
If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiment, or it may be excluded.

Embodiments of the invention will now be described with reference to the figures, in which like numerals reflect like elements throughout. The terminology used in the description presented herein is not intended to be interpreted in any restrictive or limited way, simply because it is being utilized in conjunction with the detailed description of certain specific embodiments of the invention. Furthermore, embodiments of the invention may include several novel features, no single one of which is solely responsible for its desirable attributes or which is essential to practicing the invention described herein.

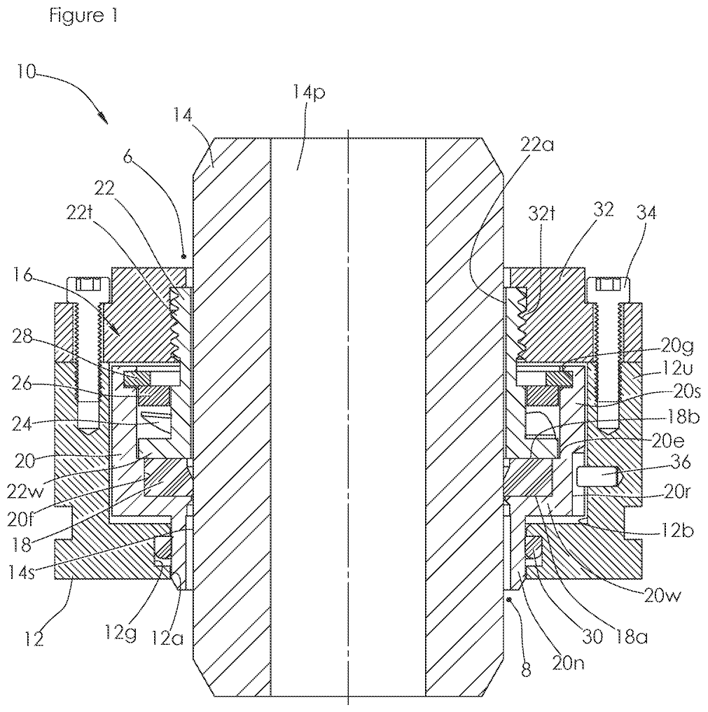

Referring now to the drawings and first to FIG. 1, a fragmentary longitudinal cross-sectional view of a sealed machine assembly is shown generally at 10. The machine assembly 10 includes a shaft 14 that is relatively movable with respect to a machine housing 12, and is relatively movable with respect to a sealing assembly 16. The sealing assembly 16 preferably comprises a number of components including a seal 18, a seal carrier 20, a retainer 22, a spring 24, a washer 26 and a retaining ring 28. The sealing assembly 16 serves to partition a first or lubricant fluid 6 from a second or environment fluid 8. The seal 18 is preferably a dynamic seal.

The shaft 14 is located at least partially within and is at least partially surrounded by the machine housing 12, dynamic seal 18, seal carrier 20, retainer 22, spring 24, washer 26 and end cap 32. A sealing surface 14s of the shaft 14 is surrounded and contacted by the dynamic seal 18, preferably a pressure-retaining seal. The shaft 14 may include an internal passage 14p. The internal passage 14p can serve various purposes, as desired. For example, the internal passage 14p may serve as a conduit for fluid or may provide an opening for receiving some other machine component.

In one embodiment the dynamic seal 18 is a rotary seal. In another embodiment the dynamic seal 18 is a hydrodynamic rotary seal. Exemplary embodiments of suitable dynamic seals are disclosed in assignee's U.S. Pat. Nos. 7,562,878; 8,056,904; 8,550,467; 9,086,151; 9,121,504; and 11,300,208. Applicant hereby incorporates U.S. Pat. Nos. 7,562,878; 8,056,904; 8,550,467; 9,086,151; 9,121,504; and 11,300,208 herein in their entireties.

The seal carrier 20 includes a neck 20n joined to a radially outward extending wall 20w which is joined to an axial extension 20s. The machine housing 12 includes a first bore portion 12a adapted to receive the neck 20n of the seal carrier 20. The first bore portion 12a preferably includes an annular groove 12g for receiving a sealing element 30, preferably an O-ring. The sealing element 30 provides a seal between the machine housing 12 and the seal carrier 20. Preferably, the sealing element 30 prevents ingress of the environment fluid 8 past the sealing element 30 between the machine housing 12 and the seal carrier neck 20n.

The first bore portion 12a of the machine housing 12 transitions to an enlarged second bore portion 12b for receiving the seal carrier outwardly extending wall 20w and the axial extension 20s as shown in FIG. 1. The outwardly extending wall 20w is also referred to as the environment side gland wall. An end cap 32 is attached to an upper portion 12u of the machine housing 12, preferably with threaded fasteners 34. The end cap 32 separates from the machine housing 12 to facilitate installation of the sealing assembly 16. It is to be understood that the enlarged second bore portion 12b has an axial length that is greater than the length of the axial extension 20s as measured from the top of the axial extension 20s to the bottom of the outwardly extending wall 20w which allows the seal carrier 20 to move axially relative to the machine housing 12.

Still referring to FIG. 1, an anti-rotation pin 36 attached to the machine housing 12 may be used to prevent the seal carrier 20 from spinning or rotating relative to the machine housing 12. The seal carrier 20 may have a recess 20r for receiving a portion of the anti-rotation pin 36. It is to be understood that there are other methods that can be used to prevent the floating seal carrier 20 from slipping in the circumferential direction.

The retainer 22 includes an axial bore 22a through which the shaft 14 extends. In the embodiment shown in FIG. 1, the retainer 22 includes a threaded portion 22t and a lower outwardly extending wall 22w. The end cap 32 includes a threaded portion 32t adapted to threadedly engage the threaded portion 22t of the retainer 22. Preferably, the end cap 32 separates from the retainer 22 to facilitate installation of the sealing assembly 16. It is to be understood that the threaded connection between the end cap 32 and the retainer 22 is just one of various methods of accomplishing the connection. Alternatively, snap rings, pins, or other techniques may be used to provide the connection therebetween.

The spring 24 is positioned around the retainer 22 and abuts the lower outwardly extending wall 22w. The spring 24 is shown in FIG. 1 as a wave spring. A stack of wave springs 24 can be used to achieve the correct spring force. Coil springs can also be used in place of wave springs. The spring 24 is compressed between the outwardly extending wall 22w of the retainer 22 and the washer 26. The washer 26 may be held in place via the snap ring 28 received within an annular groove 20g in the seal carrier 20.

When assembled, the retainer 22 and end cap 32 are fixed relative to the machine housing 12 and the seal carrier 20 “floats” and is allowed slight axial movement relative to the retainer 22, end cap 32 and machine housing 12. The fixed wall 22w of the retainer 22 supports the lubricant fluid side 18b of the seal 18 and the floating wall 20w of the seal carrier 20 supports the environment fluid side 18a of the seal 18.

The spring load acts on the floating wall 20w of the seal carrier 20 via the axial extension 20s, snap ring 28 and the washer 26. The floating wall 20w can move axially to accommodate variations in the axial width of the seal 18 while remaining in contact with the environment fluid side 18a of the seal 18. The axial width of the seal 18 may vary due to factors such as manufacturing tolerances, seal thermal expansion due to operating temperature, variations in seal radial compression due to machining tolerances of the shaft 14 and seal carrier 20, etc.

The spring-loaded gland wall seal carrier arrangement, shown in FIG. 1, prevents the seal 18 from shuttling axially when the differential pressure changes magnitude or reverses direction. In one embodiment, it is designed to operate with up to 50 psi differential pressure acting from the seal lubricant side and up to 500 psi differential pressure acting from the environment fluid side. One benefit of this arrangement is that the spring (wave spring, coil spring) 24 is isolated from the environment fluid 8. This is beneficial when there are contaminants that could build up around the spring 24 and prevent it from compressing or substances that could corrode the spring material.

Additionally, the axial extension 20s of the seal carrier 20 has an inner diameter that is slightly larger than the outer diameter of the fixed wall 22w of the retainer 22. Preferably, the axial extension 20s includes an inward ledge 20e before transitioning to a gland wall surface 20f. With reference to FIG. 1, the upward movement of the seal carrier 20 is limited by the inward ledge 20e contacting the fixed wall 22w of the retainer 22.

In FIG. 1, the sealing assembly 16 is shown subjected to reverse pressure (i.e., the differential pressure across the seal 18 is acting from the environment fluid side). It is to be understood that the floating wall 20w of the seal carrier 20 may abut the lower wall of the housing 12 when the differential pressure acting from the lubricant fluid side is high enough to compress the spring 24. The downward movement of the seal carrier 20 is limited to the gap between the lower wall of the housing 12 and the floating wall 20w as shown in FIG. 1, which prevents the spring 24 from being over-compressed.

Preferably, the hydraulic area defined by the outside diameter of the O-ring 30 and the outside diameter of the shaft 14 should be as small as possible to minimize the axial load exerted on the seal 18 when the differential pressure acts from the environment side.

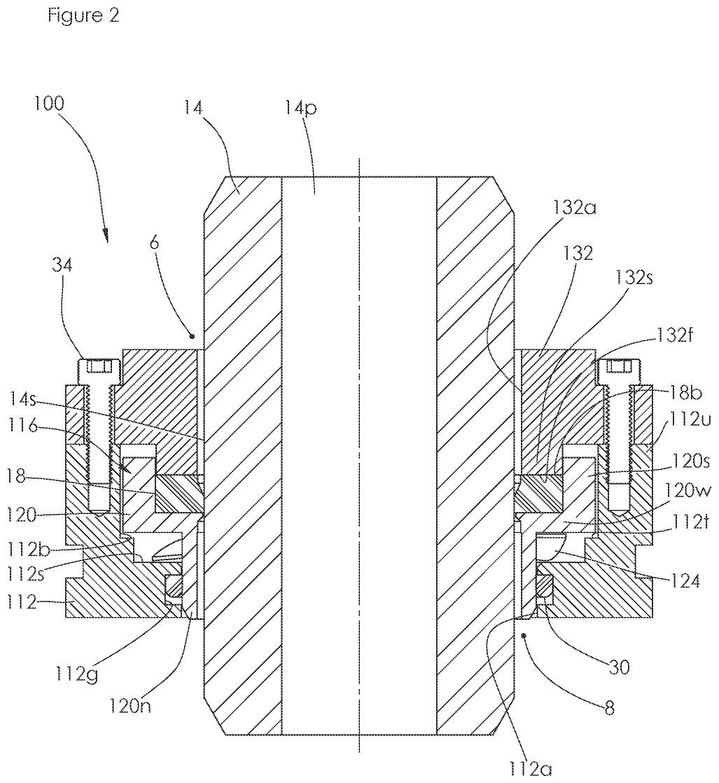

FIG. 2 is a fragmentary longitudinal cross-sectional view of an alternate embodiment of the present invention, with a sealed machine assembly shown generally at 100. The machine assembly 100 includes a shaft 14 that is relatively movable with respect to a machine housing 112, and is relatively movable with respect to a sealing assembly 116. The shaft 14 may be rotatable relative to the machine housing 112 and the sealing assembly 116. The sealing assembly 116 preferably comprises a number of components including a dynamic seal 18, a seal carrier 120, a spring 124 and an end cap 132. The sealing assembly 116 serves to partition a first or lubricant fluid 6 from a second or environment fluid 8.

The shaft 14 is located at least partially within and is at least partially surrounded by the machine housing 112, seal 18, seal carrier 120, spring 124, and end cap 132. A sealing surface 14s of the shaft 14 is surrounded and contacted by the seal 18, preferably a pressure-retaining seal. The shaft 14 may include an internal passage 14p for various purposes as described above.

The seal carrier 120 includes a neck 120n joined to a radially outward extending wall 120w which is joined to an axial extension 120s. The outward extending wall 120w is also referred to as the environment side gland wall. The machine housing 112 includes a first bore portion 112a adapted to receive the neck 120n of the seal carrier 120. The first bore portion 112a preferably includes an annular groove 112g for receiving a sealing element 30, preferably an O-ring. The sealing element 30 provides a seal between the machine housing 112 and the seal carrier 120. Preferably, the sealing element 30 prevents ingress of the environment fluid 8 between the machine housing 112 and the seal carrier neck 120n.

The first bore portion 112a of the machine housing 112 transitions to an enlarged second bore portion 112b for receiving the seal carrier outwardly extending wall 120w and the axial extension 120s as shown in FIG. 2. The end cap 132 is attached to an upper portion 112u of the machine housing 112, preferably with threaded fasteners 34. The end cap 132 separates from the machine housing 112 to facilitate installation of the sealing assembly 116. It is to be understood that the enlarged second bore portion 112b has an axial length that is greater than the length of the axial extension 120s as measured from the top of the axial extension 120s to the bottom of the outwardly extending wall 120w which allows the seal carrier 120 to move axially relative to the machine housing 112.

Although not shown in FIG. 2, an anti-rotation pin 36 as shown in FIG. 1 may be attached to the machine housing 112 to prevent the seal carrier 120 from spinning or rotating relative to the machine housing 112. The seal carrier 120 may have a recess similar to recess 20r (FIG. 1) for receiving a portion of the anti-rotation pin. It is to be understood that there are other methods that can be used to prevent the floating seal carrier 120 from slipping in the circumferential direction.

The end cap 132 includes an axial bore 132a through which the shaft 14 extends. In the embodiment shown in FIG. 2, the end cap 132 includes an inner axial extension 132s extending from a lower end of the end cap 132. Preferably, the outer diameter of the inner axial extension 132s is slightly less than the inner diameter of the axial extension 120s of the seal carrier 120. A lower face 132f of the inner axial extension 132s is designed to abut and contact the lubricant fluid side 18b of the seal 18.

The spring 124 is positioned around the neck 120n of the seal carrier 120. The spring 124 is shown in FIG. 2 as a wave spring. A stack of wave springs 124 can be used to achieve the correct spring force. Coil springs can also be used in place of wave springs. The spring 124 is compressed between the outwardly extending wall 120w of the seal carrier 120 and a machine housing surface 112s extending between the first bore portion 112a and the second bore portion 112b. Preferably, a stop 112t is provided to limit the downward movement of the seal carrier 120 and prevent over-compressing the spring 124. It is to be understood that the stop 112t may be a separate component or formed as part of the machine housing 112.

When assembled, the end cap 132 is fixed relative to the machine housing 112 and the seal carrier 120 “floats” and is allowed slight axial movement relative to the end cap 132 and machine housing 112. The fixed lower face 132f of the inner axial extension 132s of the end cap 132 supports the lubricant fluid side 18b of the seal 18 and the floating wall 120w of the seal carrier 120 supports the environment fluid side 18a of the seal 18.

The spring load acts on the floating wall 120w of the seal carrier 120. The floating wall 120w can move axially to accommodate variations in the axial width of the seal 18 while remaining in contact with the environment fluid side 18a of the seal 18.

The spring-loaded gland wall seal carrier arrangement, shown in FIG. 2, prevents the seal 18 from shuttling axially when the differential pressure changes magnitude or reverses direction. One benefit of this arrangement is that the spring (wave spring, coil spring) 124 is isolated from the environment fluid 8. This is beneficial when there are contaminants that could build up around the spring 124 and prevent it from compressing or substances that could corrode the spring material.

Additionally, the movable wall 120w of the seal carrier 120 the environment fluid side 18a of the dynamic seal 18 always maintains contact with the environment side gland wall 120w

Preferably, the hydraulic area defined by the outside diameter of the O-ring 30 and the outside diameter of the shaft 14 should be less than the hydraulic area defined by the outside diameter of the seal 18 and the outside diameter of the shaft 14 so that this area doesn't add to the required spring force necessary to keep the seal 18 in contact with the fixed end face 132f and the floating wall 120w when the environment fluid pressure is greater than the lubricant fluid pressure.

The present invention is capable of handling higher reverse pressure loads than prior designs. The present invention is capable of handling a broader range of reverse pressures than prior designs. One aspect of the present invention is that regardless of the direction of the differential pressure (forward or reverse), the environment fluid side 18a of the seal 18 always maintains contact with the environment side gland wall (i.e., movable wall) 20w, 120w of the seal carrier 20, 120. As a result, seal skew is eliminated or greatly reduced even when experiencing differential pressures between forward and reverse directions.

### NOMENCLATURE

lubricant fluid 6
environment fluid 8
sealed machine assembly 10
machine housing 12
first bore portion 12a
second bore portion 12b
annular groove 12g
upper portion 12u
shaft 14
internal passage 14p
sealing surface 14s
sealing assembly 16
dynamic seal 18
environment fluid side 18a
lubricant fluid side 18b
seal carrier 20
inward ledge 20e
gland wall surface 20f
groove 20g
neck 20n
recess 20r
axial extension 20s
wall 20w
retainer 22
threaded portion 22t
wall 22w
spring 24
washer 26
retaining ring 28
sealing element 30
end cap 32
threaded portion 32t
fasteners 34
anti-rotation pin 36
sealed machine assembly 100
machine housing 112
first bore portion 112a
second bore portion 112b
annular groove 112g
machine housing surface 112s
stop 112t
upper portion 112u
sealing assembly 116
seal carrier 120
neck 120n
axial extension 120s
wall 120w
spring 124
end cap 132
axial bore 132a
lower face 132f
inner axial extension 132s

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

What is claimed is:

1. A sealing assembly for forward and reverse differential pressure, the sealing assembly comprising:
a housing of annular form having a first bore portion and a second bore portion, the first bore portion joined to the second bore portion by a housing surface;
a lubricant fluid having a lubricant fluid pressure and an environment fluid having an environment fluid pressure;
a shaft being relatively movable with respect to the housing and defining a radially outward-facing sealing surface;
a seal carrier of annular form located radially outward of and encircling at least a portion of the sealing surface of the shaft, the seal carrier having an annular neck transitioning to an outwardly extending wall and having an axial extension adjoining the outwardly extending wall, the annular neck extending through the first bore portion and the axial extension and wall positioned within the second bore portion of the housing;
a dynamic seal located between and having sealing contact with the axial extension and the shaft and partitioning the lubricant fluid from the environment fluid, the dynamic seal having a lubricant fluid side exposed to the lubricant fluid and an environment fluid side exposed to the environment fluid;
an end cap of annular form secured to the housing, the end cap and the housing located radially outward of and encircling at least a portion of the shaft, the end cap having an inner axial extension with an end face;
a spring located around the neck and between the housing surface and the outwardly extending wall of the seal carrier,
wherein the seal carrier is allowed to have limited axial movement relative to the housing and the end cap,
wherein the dynamic seal is axially located between the end face of the end cap and the outwardly extending wall of the seal carrier.

2. The sealing assembly of claim 1, wherein the spring applies an axial spring force to the seal carrier to maintain the lubricant fluid side of the dynamic seal in contact with the end face of the end cap and the outwardly extending wall of the seal carrier in contact with the environment fluid side of the dynamic seal.

3. The sealing assembly of claim 1, wherein the first bore portion of the housing includes an annular groove and a sealing element is received in the annular groove and forms a seal between the housing and the neck of the seal carrier.

4. The sealing assembly of claim 2, wherein the first bore portion of the housing includes an annular groove and a sealing element is received in the annular groove and forms a seal between the housing and the neck of the seal carrier.

5. The sealing assembly of claim 3, wherein the sealing element prevents the environment fluid from contacting the spring.

6. The sealing assembly of claim 4, further comprising a stop attached to or formed in the housing, the stop limiting axial movement in the direction of spring compression.

7. The sealing assembly of claim 1, wherein the spring is maintained in compression.

8. The sealing assembly of claim 1, wherein the inner axial extension of the end cap has an outer diameter that is smaller than an inner diameter of the axial extension of the seal carrier.

9. The sealing assembly of claim 1, wherein the shaft is a rotary shaft and the dynamic seal is a hydrodynamic rotary seal.

10. The sealing assembly of claim 1, wherein the spring is located on the environment fluid side of the dynamic seal.

11. A sealing assembly for forward and reverse differential pressure, the sealing assembly comprising:
a housing of annular form having a first bore portion and a second bore portion, the first bore portion joined to the second bore portion by a housing surface;
a lubricant fluid having a lubricant fluid pressure and an environment fluid having an environment fluid pressure;
a shaft being relatively movable with respect to the housing and defining a radially outward-facing sealing surface;
a seal carrier of annular form located radially outward of and encircling at least a portion of the sealing surface of the shaft, the seal carrier having an annular neck transitioning to an outwardly extending wall and having an axial extension adjoining the outwardly extending wall, the annular neck extending through the first bore portion and the axial extension and wall positioned within the second bore portion of the housing;
a dynamic seal located between and having sealing contact with the axial extension and the shaft and partitioning the lubricant fluid from the environment fluid, the dynamic seal having a lubricant fluid side exposed to the lubricant fluid and an environment fluid side exposed to the environment fluid;
an end cap of annular form secured to the housing;
a retainer of annular form connected to the end cap, the retainer including an outwardly extending wall,
wherein the end cap, retainer and housing are located radially outward of and encircle at least a portion of the shaft;
a washer located between the retainer and the axial extension of the seal carrier;
a spring located around the retainer and between the retainer outwardly extending wall and the washer;
wherein the seal carrier is allowed to have limited axial movement relative to the housing and the retainer, and
wherein the dynamic seal is axially located between the retainer outwardly extending wall and the outwardly extending wall of the seal carrier.

12. The sealing assembly of claim 11, wherein the spring applies an axial spring force to the seal carrier to maintain the lubricant fluid side of the dynamic seal in contact with the retainer outwardly extending wall and the outwardly extending wall of the seal carrier in contact with the environment fluid side of the dynamic seal.

13. The sealing assembly of claim 11, wherein the first bore portion of the housing includes an annular groove and a sealing element is received in the annular groove and forms a seal between the housing and the neck of the seal carrier.

14. The sealing assembly of claim 12, wherein the first bore portion of the housing includes an annular groove and a sealing element is received in the annular groove and forms a seal between the housing and the neck of the seal carrier.

15. The sealing assembly of claim 13, wherein the sealing element prevents the environment fluid from contacting the spring.

16. The sealing assembly of claim 11, wherein the spring is maintained in compression.

17. The sealing assembly of claim 11, wherein the shaft is a rotary shaft and the dynamic seal is a hydrodynamic rotary seal.

18. The sealing assembly of claim 11, wherein the spring is located on the lubricant fluid side of the dynamic seal.
